(19) United States
(12) Patent Application Publication
(10) Pub. No.: US 2007/0208582 A1
(43) Pub. Date: Sep. 6, 2007

(54) Method, system, and program product for providing an aggregated view

(75) Inventors: Sudhakar V. Chellam, Apex, NC (US); Niraj P. Joshi, Cary, NC (US); Rosalind T. A. Radcliffe, Durham, NC (US); Robert T. Uthe, Morrisville, NC (US)

Correspondence Address: HOFFMAN WARNICK & DALESSANDRO LLC, 75 STATE ST, 14TH FLOOR, ALBANY, NY, 12207, US

(73) Assignee: International Business Machines Corporation, Armonk, NY (US)

(21) Appl. No.: 11/366,153

(22) Filed: Mar. 2, 2006

(51) Int. Cl. G06F 9/00

(52) U.S. Cl. 705/1; 715/734; 715/733

(57) ABSTRACT

The invention provides a method, system, and program product for providing an aggregated view. In one embodiment, the invention includes selecting at least one criterion satisfied by at least two components of a system; aggregating the at least two components based on their provision of a same service at different sites within the system; and displaying the aggregated components within a graphical display.

### BACKGROUND OF THE INVENTION

1. Technical Field

The invention relates generally to graphical displays, and more particularly, to a method, system, and program product for providing an aggregated view based on one or more logical criterion.

2. Background Art

Topology displays are commonly used to represent relationships among components of a system. Such relationships may include, for example, communications links, data transfers, and/or an organizational hierarchy. The difficulty with known topology displays is that as components are added to the system and/or more relationships are shown among its components, the complexity of the displays increases. Eventually, this increasing complexity decreases the usefulness of representing the system as a topology display. This is particularly problematic in the display of service-oriented systems, where a large number of service nodes must be shown.

For example, referring to FIG. 1, a topology display 100 is shown for a retail service environment. For the sake of brevity, topology display 100 is shown including three retail sites: Atlanta 110, New York 130, and Los Angeles 150. It should be recognized, of course, that many more sites may be included in a typical topology display.

As can be seen in FIG. 1, each site 110, 130, 150 includes the same components: shipping 112, 132, 152; warehouse 114, 134, 154; retail space 116, 136, 156; customer service 118, 138, 158; Internet sales 120, 140, 160; and phone sales 122, 142, 162. Arrows linking individual components may represent, for example, one-way or two-way communications or data transfers between the components. As can also be seen in FIG. 1, the broken arrow between phone sales 142 and warehouse 134 at the New York site 130 indicates a change in status, such as failure, of the relationship between these components. Each component may represent a component particular to a site (e.g., retail space 116 in Atlanta is specific to the Atlanta site and no other site) or may represent components shared among two or more sites (e.g., Internet sales 120, 140, 160 may be a single service shared among each site). In either case, much of the space within topology display 100 is “wasted,” in that it is used to represent components that are equivalent to components already displayed or are duplicative of a single component.

Referring to FIG. 2, another topology display 200 known in the art is shown. Unlike the topology display 100 of FIG. 1, topology display 200 includes aggregated components, resulting in a more simplified display. However, as shown in FIG. 2, components shared among all sites (e.g., Internet sales 220 and customer service 218) are shown only once, and are shown in relation only to each site 210, 230, 250 rather than to each site's components. As such, the relationships between shared components and site components, as well as between individual site components, are lost in displays such as that of FIG. 2.

To this extent, a need exists for a method, system, and program product that simplifies graphical displays, particularly topology displays, by aggregating the display of equivalent and/or duplicative components.

### SUMMARY OF THE INVENTION

The invention provides a method, system, and program product for providing an aggregated view. In one embodiment, the invention includes selecting at least one criterion satisfied by at least two components of a system; aggregating the at least two components based on their provision of a same service at different sites within the system; and displaying the aggregated components within a graphical display.

A first aspect of the invention provides a method for providing an aggregated view, the method comprising: aggregating at least two components of a system based on their provision of a same service at different sites within the system; and displaying the aggregated components within a graphical display.

A second aspect of the invention provides a system for providing an aggregated view, the system comprising: a system for aggregating at least two components of a system based on their provision of a same service at different sites within the system; and a system for displaying the aggregated components within a graphical display.

A third aspect of the invention provides a program product stored on a computer-readable medium, which when executed, provides an aggregated view, the program product comprising: program code for aggregating at least two components of a system based on their provision of a same service at different sites within the system; and program code for displaying the aggregated components within a graphical display.

A fourth aspect of the invention provides a method for deploying an application for providing an aggregated view, comprising: providing a computer infrastructure being operable to: aggregate at least two components of a system based on their provision of a same service at different sites within the system; and display the aggregated components within a graphical display.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a known topology display.

FIG. 2 shows a known aggregated topology display.

FIGS. 3A-C show a topology display according to an embodiment of the invention.

FIGS. 4A-D show a topology display according to an alternative embodiment of the invention.

FIG. 5 shows a block diagram of an illustrative method according to the invention.

FIG. 6 shows an illustrative system according to the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION

As indicated above, the invention provides a method, system, and program product for providing an aggregated system view.

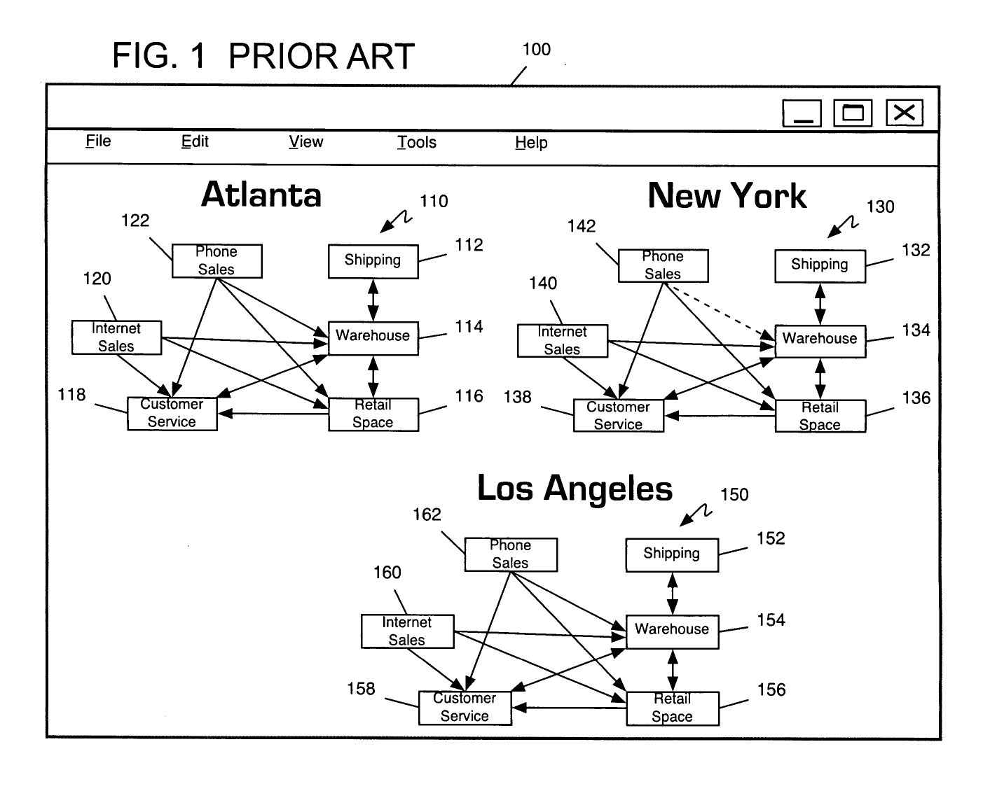

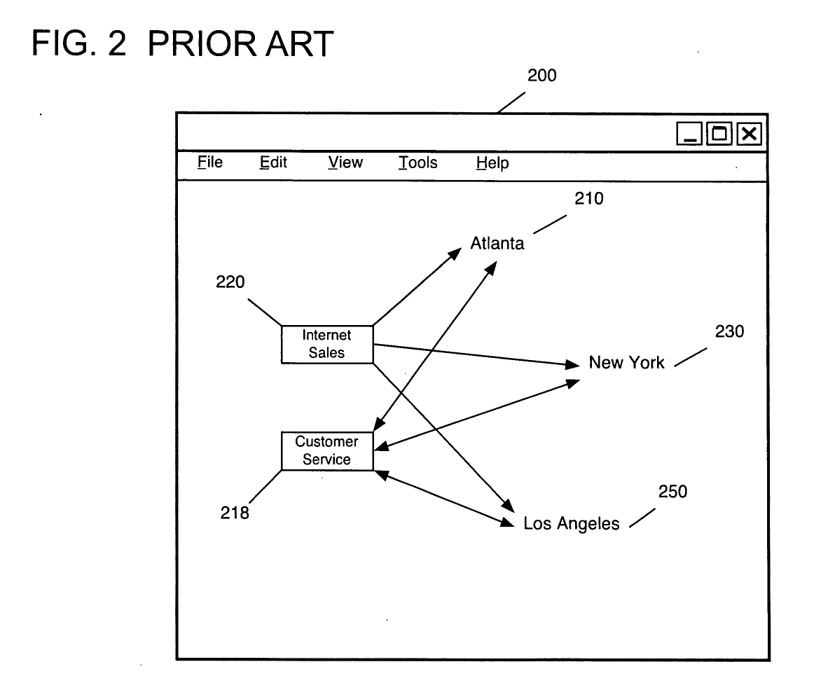

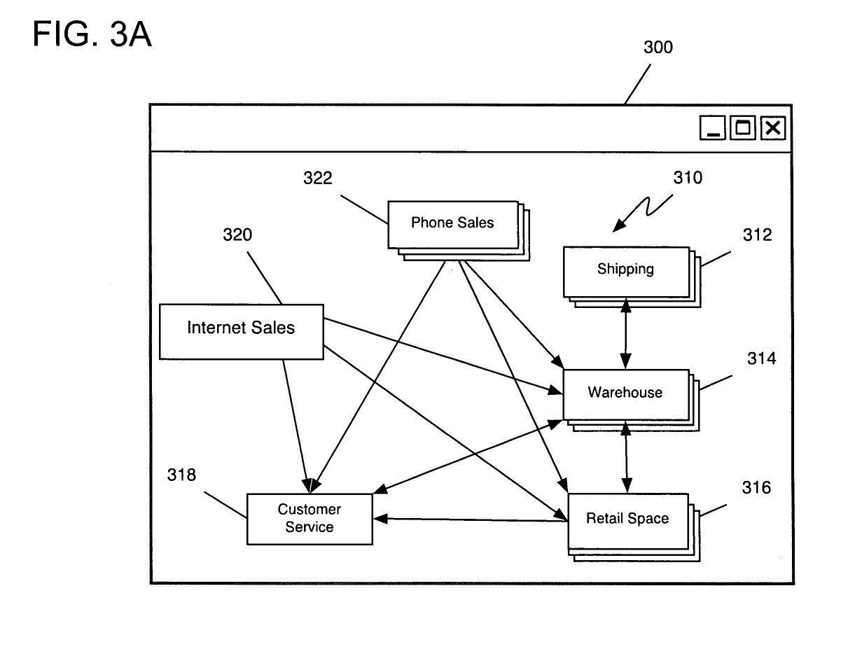

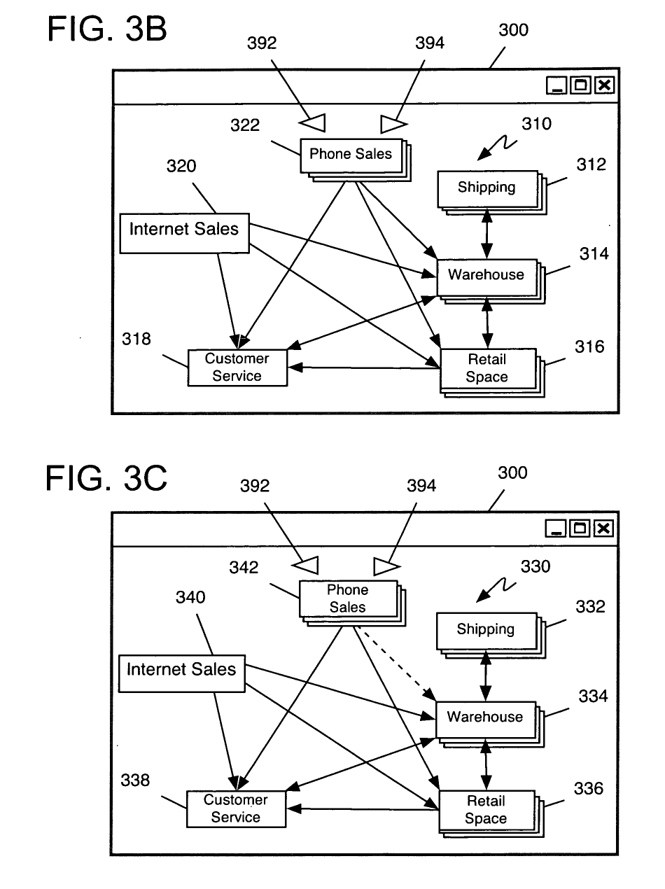

FIGS. 3A-C show various views of a topology display 300 according to one embodiment of the invention. Topology display 300 is greatly simplified as compared to topology display 100 of FIG. 1 without sacrificing the relevant data, as in topology display 200 of FIG. 2. Specifically, components common to all sites (i.e., phone sales 322, shipping 312, warehouse 314, and retail space 316) are each represented as a logical construct in association with components shared by all sites (i.e., Internet sales 320 and customer service 318). Aggregated components 312, 314, 316, 322 are displayed as “stacked” components to indicate that they are aggregated views of multiple individual components. Other methods of such indication are possible, of course. Alternatively, no such indication may be used.

FIGS. 3B-C show alternative views of topology display 300. Cycling buttons 392, 394 allow a user to alter topology display 300 to correspond to various sites 310, 330, the components of which have been aggregated. For example, referring to FIG. 3B, topology display 300 represents the components applicable to the Atlanta site 310. Upon activating or selecting forward cycling button 394, topology display 300 is altered to that shown in FIG. 3C, representing the components applicable to the New York site 330. As can be seen in FIG. 3C, the relationship between phone sales 342 and warehouse 342 is represented by a broken arrow, indicating a change in status, such as failure, of the relationship between these components. Cycling buttons 392, 394 may be used to alternately represent components and/or relationships between components associated with individual sites.

Because topology display 300 includes logically aggregated components, it may not be desirable or possible to perform administrative, operational, or maintenance tasks commonly performed through the use of a topology display. For example, in order to ensure that such tasks are not inadvertently performed on an aggregated component, it may be desirable to restrict the ability of a user to perform such tasks to non-aggregated components. However, it may still be necessary to perform such tasks on aggregated components. In such a case, it may be desirable to provide a non-aggregated view of a system's components in addition to an aggregated view.

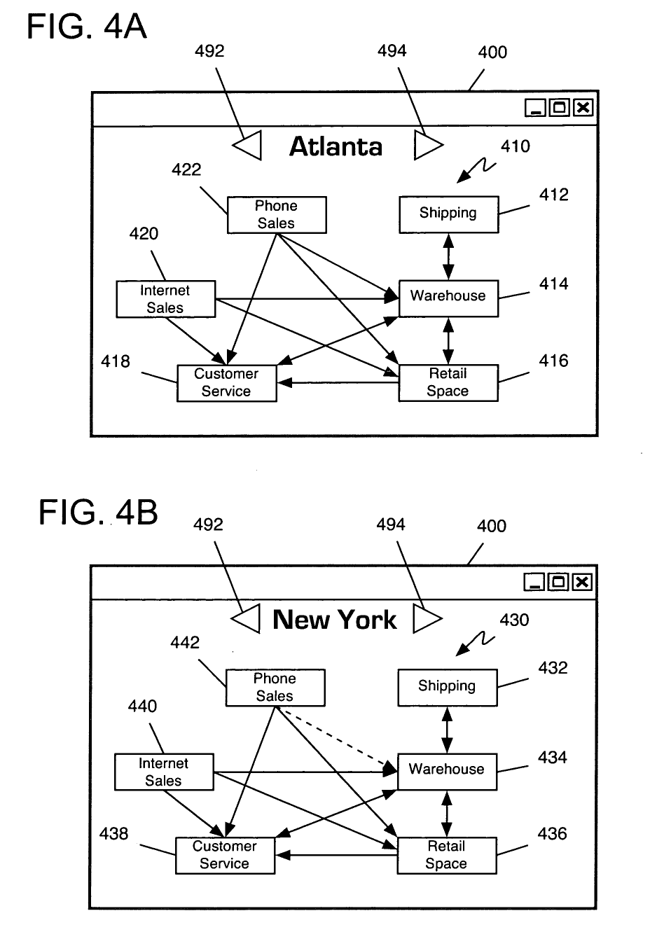

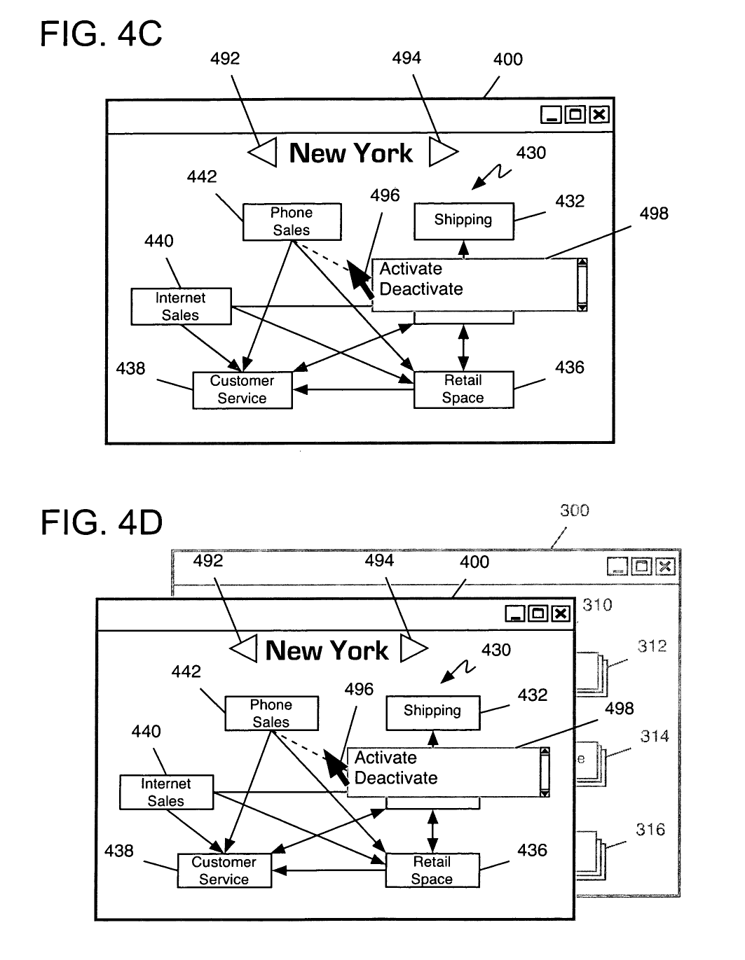

To this end, FIGS. 4A-D show a non-aggregated topology display 400 according to the invention. Rather than showing all aggregated and non-aggregated components in a single display, as in FIG. 3A, non-aggregated topology display 400 shows all components for a particular site (i.e., system components are aggregated by site). In FIG. 4A, components associated with the Atlanta site 410 are shown. As shown in FIG. 4A, non-aggregated topology display 400 may include all system components applicable to the Atlanta site 410, such as Internet sales 420 and customer service 418, even if such components are also applicable to other sites. Alternatively, non-aggregated topology display 400 may include only system components unique to the Atlanta site 410 (e.g., shipping 412, warehouse 414, retail space 416, and phone sales 422). In order to provide access to components associated with other sites, non-aggregated topology display 400 may include cycling buttons 492, 494, as described above, for cycling non-aggregated topology display 400 to show components associated with other sites. For example, FIG. 4B shows non-aggregated topology display 400 after activating forward cycling button 494. As shown in FIG. 4B, non-aggregated topology display 400 includes system components applicable to the New York site 430. As in FIG. 3C, the relationship between phone sales 442 and warehouse 434 is shown as a broken line, generally depicting a failure or other change in status of this relationship. In order to inform a user of such a change in status, non-aggregated topology display 400 may be adapted to automatically cycle to display system components including such a change in status.

As explained above, non-aggregated topology display 400 may be employed in the performance of maintenance tasks, administrative tasks, etc. In FIG. 4C, a command window 498 has been activated, permitting the selection of one or more administrative, operational, or maintenance tasks (e.g., Activate, Deactivate, etc.). Command window 498 may be activated, for example, by “right clicking” after positioning a mouse arrow 496 adjacent a system component (e.g., phone sales 442) of interest. Any number of administrative, operational, or maintenance tasks may then be selected and applied to the system component of interest.

FIG. 4D shows non-aggregated topology display 400 of FIG. 4C as a “pop-up window” above topology display 300 (shown in phantom) of FIG. 3A. In one embodiment of the invention, non-aggregated topology display 400 may be adapted to replace or supplement aggregated topology display 300 automatically, in the case, for example, that a status of an aggregated system component changes.

As described above, the present invention allows the logical aggregation of system components based on their mutual satisfaction of one or more criterion. Such criteria may include, for example, equivalence in function, participation or involvement in a common business process or transaction, conformance with a predefined rule, policy, or configuration, etc. In short, any criterion may be used to aggregate system components, depending upon the type of system involved. That is, while shown in the accompanying figures as involving a service-oriented system, and particularly a retail-based, service-oriented system, any system amenable to the aggregation of its components based on a logical construct may be employed in practicing the present invention. Such systems include, for example, information technology (IT) systems.

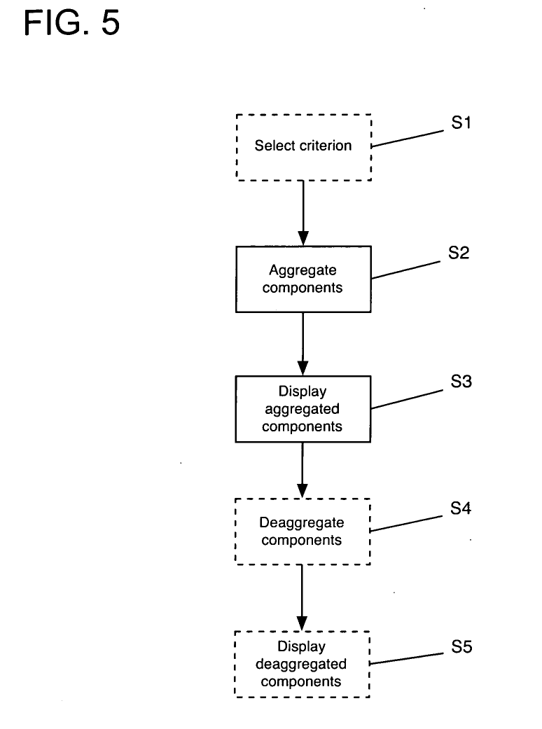

FIG. 5 shows a block diagram of an illustrative method according to the invention. At optional step S1, a criterion or criteria are selected upon which system components will be aggregated. In the case that such criteria are predefined or predetermined, step S1 may be omitted. At step S2, two or more system components are aggregated, based upon their mutual satisfaction of one or more criterion. Next, at step S3, the components aggregated at step S2 are displayed. Preferably, relationships between aggregated system components are also displayed at step S3. Any number of display types may be employed at step S3, although a topology display is preferred.

As explained above, in the event that a status of one or more aggregated components changes, it may be desirable to separately display such components following their deaggregation. Accordingly, at optional step S4, aggregated components may be deaggregated and then displayed at optional step S5. The display of deaggregated components at optional step S5 may be made within the display of step S3 or in a different display.

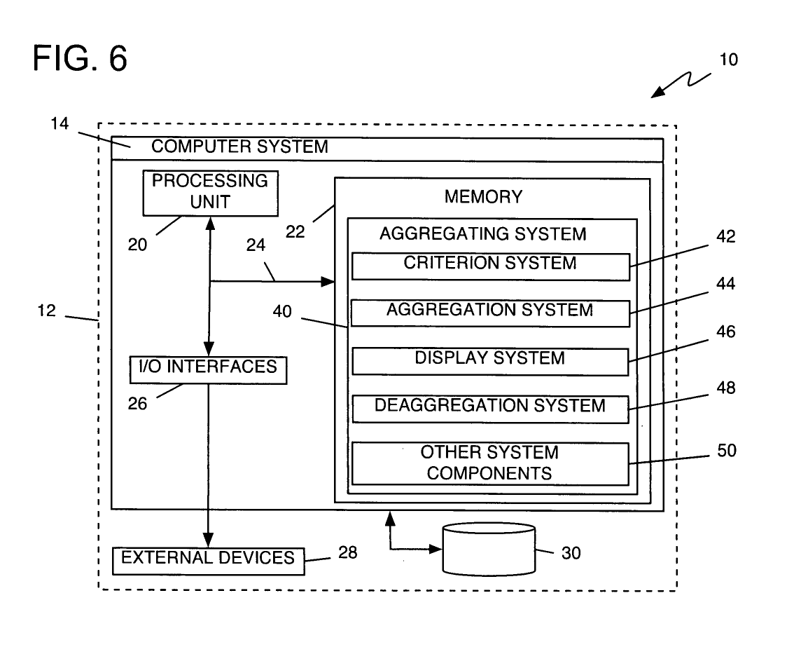

FIG. 6 shows an illustrative system 10 for providing an aggregated system view. To this extent, system 10 includes a computer infrastructure 12 that can perform the various process steps described herein for providing an aggregated system view. In particular, computer infrastructure 12 is shown including a computer system 14 that comprises an aggregating system 40, which enables computer system 14 to provide an aggregated system view by performing the process steps of the invention.

Computer system 14 is shown including a processing unit 20, a memory 22, an input/output (I/O) interface 26, and a bus 24. Further, computer system 14 is shown in communication with an external devices 28 and a storage system 30. As is known in the art, in general, processing unit 20 executes computer program code, such as aggregating system 40, that is stored in memory 22 and/or storage system 30. While executing computer program code, processing unit 20 can read and/or write data from/to memory 22, storage system 30, and/or I/O interface 26. Bus 24 provides a communication link between each of the components in computer system 14. External devices 28 can comprise any device that enables a user (not shown) to interact with computer system 14 or any device that enables computer system 14 to communicate with one or more other computer systems.

In any event, computer system 14 can comprise any general purpose computing article of manufacture capable of executing computer program code installed by a user (e.g., a personal computer, server, handheld device, etc.). However, it is understood that computer system 14 and aggregating system 40 are only representative of various possible computer systems that may perform the various process steps of the invention. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computer systems (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computer systems may utilize any combination of various types of transmission techniques.

As previously mentioned, aggregating system 40 enables computer system 14 to provide an aggregated system view. To this extent, aggregating system 40 is shown including a criterion system 42, an aggregation system 44, a display system 46, and a deaggregation system 48. Operation of each of these systems is discussed above. For example, criterion system 42 may set, allow a user to set, or evaluate one or more criterion upon which components will be aggregated (e.g., their provision of a same service); aggregation system 44 may aggregate two or more components; display system 46 may display both aggregated and nonaggregated system components; and deaggregation system 48 may deaggregate previously aggregated components based on a change in status of one or more components. Aggregating system 40 may further include other system components 50 to provide additional or improved functionality to aggregating system 40. It is understood that some of the various systems shown in FIG. 6 can be implemented independently, combined, and/or stored in memory for one or more separate computer systems 14 that communicate over a network. Further, it is understood that some of the systems and/or functionality may not be implemented, or additional systems and/or functionality may be included as part of system 10.

While shown and described herein as a method and system for providing an aggregated system view, it is understood that the invention further provides various alternative embodiments. For example, in one embodiment, the invention provides a computer-readable medium that includes computer program code to enable a computer infrastructure to provide an aggregated system view. To this extent, the computer-readable medium includes program code, such as aggregating system 40, that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computer system, such as memory 22 and/or storage system 30 (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider could offer to provide an aggregated system view as described above. In this case, the service provider can create, maintain, support, etc., a computer infrastructure, such as computer infrastructure 12, that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for providing an aggregated system view. In this case, a computer infrastructure, such as computer infrastructure 12, can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computer system, such as computer system 14, from a computer-readable medium; (2) adding one or more computer systems to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computer system having an information processing capability to perform a particular function either directly or after either or both of the following: (a) conversion to another language, code or notation; and (b) reproduction in a different material form. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for providing an aggregated view, the method comprising:
aggregating at least two components of a system based on their provision of a same service at different sites within the system; and
displaying the aggregated components within a graphical display.

2. The method of claim 1, wherein the graphical display is a topology display.

3. The method of claim 1, wherein the graphical display includes aggregated and non-aggregated components.

4. The method of claim 1, wherein the graphical display includes means for alternately displaying the components of each site within the system.

5. The method of claim 1, further comprising:
deaggregating the at least two components in the case that a status of at least one of the at least two components changes.

6. The method of claim 5, further comprising:
separately displaying the at least one component having a changed status.

7. The method of claim 5, wherein the change in status includes a failure of the at least one component.

8. A system for providing an aggregated view, the system comprising:
a system for aggregating at least two components of a system based on their provision of a same service at different sites within the system; and
a system for displaying the aggregated components within a graphical display.

9. The system of claim 8, wherein the graphical display is a topology display.

10. The system of claim 8, wherein the graphical display includes aggregated and non-aggregated components.

11. The system of claim 8, wherein the graphical display includes means for alternately displaying the components of each site within the system.

12. The system of claim 8, further comprising:
a system for deaggregating the at least two components in the case that a status of at least one of the at least two components changes.

13. The system of claim 12, further comprising:
a system for separately displaying the at least one component having a changed status.

14. The system of claim 12, wherein the change in status includes a failure of the at least one component.

15. A program product stored on a computer-readable medium, which when executed, provides an aggregated view, the program product comprising:
program code for aggregating at least two components of a system based on their provision of a same service at different sites within the system; and
program code for displaying the aggregated components within a graphical display.

16. The program product of claim 15, wherein the graphical display is a topology display.

17. The program product of claim 15, wherein the graphical display includes aggregated and non-aggregated components.

18. The program product of claim 15, wherein the graphical display includes means for alternately displaying the components of each site within the system.

19. The program product of claim 15, further comprising:
program code for deaggregating the at least two components in the case that a status of at least one of the at least two components changes; and
program code for separately displaying the at least one component having a changed status.

20. A method for deploying an application for providing an aggregated view, comprising:
providing a computer infrastructure being operable to:
aggregate at least two components of a system based on their provision of a same service at different sites within the system; and
display the aggregated components within a graphical display.
